(19) United States
(12) Patent Application Publication
(10) Pub. No.: US 2005/0034580 A1
(43) Pub. Date: Feb. 17, 2005

(54) Device for transversally cutting into portions a continuous strip of containers

(76) Inventors: Primo Finetti, Mirandola (IT); Andrea Bartoli, Reggio Emilia (IT)

Correspondence Address: NIXON & VANDERHYE, PC, 1100 N GLEBE ROAD, 8TH FLOOR, ARLINGTON, VA, 22201-4714, US

(21) Appl. No.: 10/502,635

(22) PCT Filed: Jan. 21, 2003
(86) PCT No.: PCT/IB03/00132

(30) Foreign Application Priority Data
Jan. 24, 2002 (IT) M02002A000015

(51) Int. Cl. B26D 5/20

(52) U.S. Cl. 83/209; 83/946

(57) ABSTRACT

A device for transversally cutting into portions a continuous strip of containers comprises a severing station arranged to receive the different containers of the strip in a preset severing position, one after another, intermittently. A dragging drum, that is commanded to rotate by a brushless motor provided with a controller, is peripherally provided with seats that are arranged around in a circumference and are coupled with the containers so as to make the strip to advance towards the severing station. A sensor, arranged upstream of the severing station, detects the position of each container and supplies to the controller a corresponding position signal used to correspondingly command the strip to advance so as to correctly position said container in the preset severing position. The device enables the different containers of the strip to be divided with great accuracy.

The subject of the present invention is a device for transversally cutting into portions a continuous strip of containers.

Specifically, but not exclusively, this invention can be advantageously applied in the context of a machine for forming, filling and sealing containers arranged in a continuous strip.

Machines of this type generally comprise a production line along which one or more continuous strips of filled and sealed containers are obtained from one or more continuous webs of film material that is unwound from a reel. At the end of the production line, the strip of containers is fed to a severing station in which the containers, by means of a device for transversally cutting the strip, are divided singularly or into portions of two or more containers. The main object of the present invention is to provide a cutting device that divides the different containers of the strip with great accuracy.

One advantage of the invention is to obtain a device that is contructionally simple and cheap.

Another advantage is to make available a device having a particularly reliable, rapid and versatile operation. These objects and advantages and yet others are all achieved by the invention in subject, as it is characterised by the claims set out below.

Further features and advantages of the present invention will become more apparent from the following detailed description of an embodiment of the invention in subject shown by way of non-limitative example in the attached drawings.

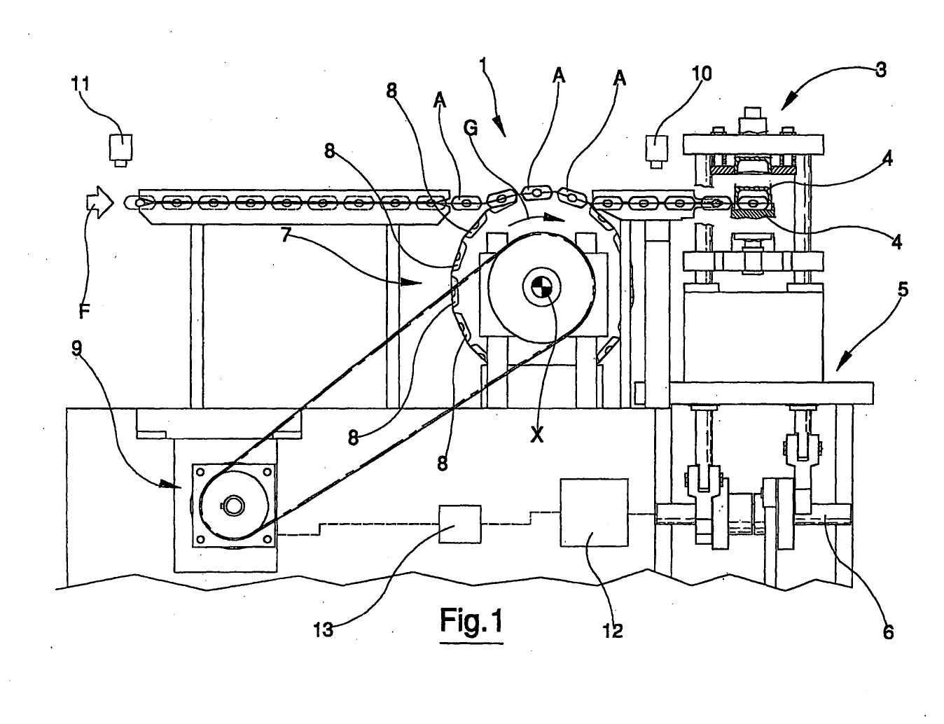

FIG. 1 shows a vertically raised view, with some cross-sectioned parts, of a device obtained according to the present invention.

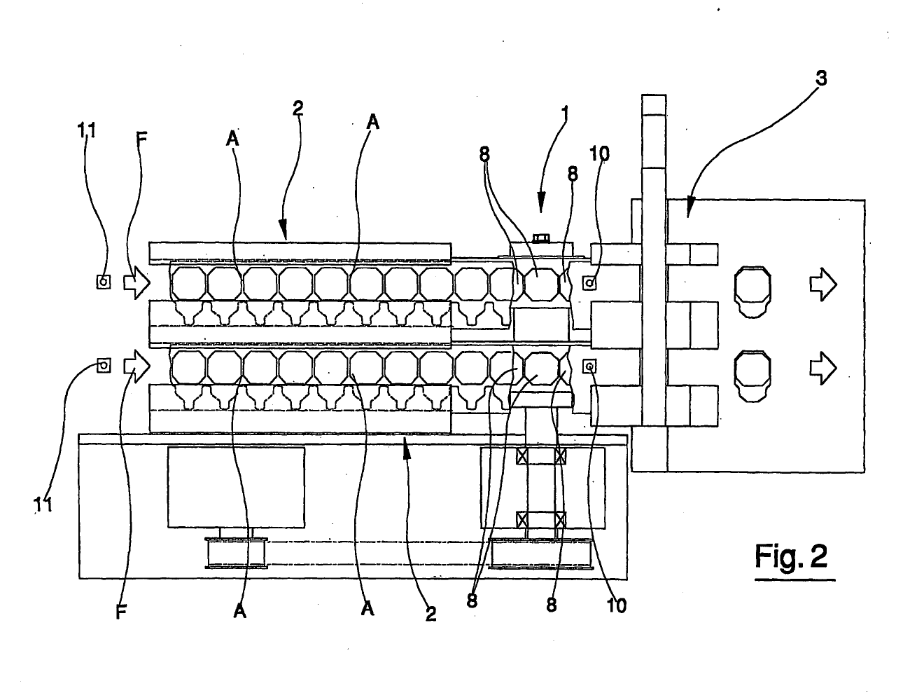

FIG. 2 shows a plan view from above of FIG. 1.

With reference to the above mentioned Figures, 1 shows altogether a device for the transversal cutting in portions of at least one continuous strip of filled and sealed containers. In the case in point, the device is arranged to cut two parallel and side-by-side strips 2 of containers A.

Each strip 2 is obtained, in known manner, along a production line comprising different operating stations for forming containers, starting with one or more continuous strips of film material unwound from reels, for filling and sealing the containers obtained. The material of the webs is preferably a thermoformable and heat-sealable plastic material. The containers A are distributed along the strip 2 so as to be spaced out with a preset regular and constant step. The strip of containers that reaches the cutting device 1 comes preferably directly from said production line along an advancing direction F.

The transversal cutting device 1 comprises a severing station 3 arranged to receive the different containers of each strip in a preset severing position. The containers A are positioned intermittently at the severing station, one after the other. At each advancing step in direction F, the container A, that is correctly positioned at the severing position, is separated from the strip by means of a transversal cutting carried out by two opposed severing members.

Said severing members comprise two cutting half-moulds 4 that work together and are located by opposite parts of the strip, one of them being located at the top and the other one at the bottom.

The severing members are commanded to open and close by a known moving mechanism 5 that is shown schematically, and is connected to an actuating shaft 6 that receives movement from first motor means. The latter comprises a motor whose operating features are regulated by an electronic control system: the motor in question is preferably a brushless motor 12.

At the severing station 3 is further provided known evacuation means, not shown, in order to remove the single containers A, that are separated from the strip, after cutting.

The device further comprises a feed line for indexing the strips of containers to the severing station 3 with a controlled advancing step. In the case in point, each strip advances with a substantially horizontal lying plane.

The feed line comprises a drum 7 for dragging the strip forward that can be commanded to rotate in direction G by second motor means, with a horizontal rotation axis x which is perpendicular to the advancing direction F of the strip of containers. Hollow seats 8, suitable for receiving the containers A, are peripherally provided at the rotating drum 7. The seats 8 are arranged in a circumference at a preset step that corresponds to the step with which the containers A are distributed on the strip. The seats 8 of the rotating drum are coupled to the containers of the strip so as to command the advancing F of the strip towards the blanking station 3.

The drum 7 that commands the advancing of the strip is rotated by second motor means that is controlled by an electronic control unit and that is distinct from the first motor means. In the preferred embodiment here described, the second motor means comprises a brushless motor 9 provided with an electronic control unit (of the known type and not shown) comprising a usual controller.

The device 1 preferably comprises at least a first sensor 10 (in this case two sensors, one for each strip being advanced towards the severing station) which is arranged upstream of the severing station to detect the position of each container A of the strip. The sensor 10 is a known position sensor. Each first sensor 10 preferably operates between the dragging drum 7 and the severing station 3, immediately upstream of the latter. The first sensor 10 is arranged to provide, for each container A moving towards the severing station, a corresponding position signal to the control unit of the second motor means. Said control unit processes the signal to cause the strip to advance, the signal is such as to correctly position the container to which the position signal refers at the preset severing position.

The sensor 10 is substantially part of a retroactive regulating system for regulating the positioning of the containers, one at a time, at the severing station: said regulating system acts on the feeding means for feeding the strip to the severing station principally in order to eliminate the errors in positioning the containers at the station.

The device 1 is further, preferably, provided with at least one second sensor 11 (preferably at least one per each container strip) arranged to detect a faulty situation for one or more containers arranged on the feed line upstream of the severing station. The faulty situation could be, for example, non-filling or incorrect filling of the container, or irregular forming of the container, or other faults that may make the container unsuitable for sale and therefore destined for rejection. Every second sensor 11, operationally associated with each strip of containers, is of known type and it is not described in detail: the choice of the second sensors obviously depends on the type of faults that need to be detected to determine non-compliance of the container with the required standard.

Every second sensor 11 supplies a command signal to the control unit of the motor means that make the strip to advance. The control unit receives and processes the signal to consequently appropriately cause the strip to advance in such a way as to override the stop at the blanking station 3 of the container, or of the containers, for which a faulty situation was detected.

The two actuating brushless motors 9 and 12 for respectively actuating the dragging drum 7 and the severing station 3 are both connected to a single electronic control unit 13 that operates both motors in a mutually coordinated manner.

The control unit 13 can, for example, command a preset group of containers to advance through the severing station without undergoing severing: in other words, can be regulated the number of containers that are advanced at each severing stroke (whereby a severing stroke is defined as a single closing and opening cycle of the severing members). The control unit 13 is further arranged to control a required variation of the rotation angle of which the dragging drum 7 rotates at each advancing step, namely the control unit is arranged to adjust the advancing step of the strip of containers. The control unit 13 can further control the operating sequence of the severing members, particularly, with the possibility of keeping under control, instant by instant, the stress to which said members are subjected: the control unit can further recognise any faults in the proceeding of said stresses (by means of comparison with a normal expected proceeding) and provide an alarm signal with subsequent arrest of severing operations: a fault could consist, for example, in an incorrect positioning of the container, because of which the severing members would work on the swollen part suitable for containing a material of the container rather than on the flat sealed part of the container that separates the two adjacent swollen parts: in this case the cutting members, that meet a cutting resistance earlier than expected, are stopped in time before breaking the swollen part, thereby avoiding the dispersion of filling material.

During operation, the dragging drum rotates with a rotation angle that corresponds to the advancing by a step of the containers so as to position a container at the severing station, after which the severing members are actuated to effect transversal cutting of the container.

If an operating feature of the severing station (e.g. the torque on the rotating shaft 6) does not correspond to a preset proceeding (e.g. because the severing members are working erroneously on the swollen part of the container so that they find the material to be cut earlier than expected), severing operation is immediately stopped.

If the first sensor 10 is provided, when a container of a strip passes in front of the first sensor 10, the latter detects its position and supplies a relative signal that is sent to the controller of the actuating motor 9 of the dragging drum. The controller therefore commands at the correct moment (i.e. when said container has to be positioned at the severing station), a rotation of the drum 7, because of which the strip advances by the exact amount for placing the container in the correct position.

In this position, the severing members separate the container from the strip. In this way the indexing of the strip is each time controlled, so as to ensure the exact positioning of all the containers and to thereby avoid severing errors that may lead to the rejection of the container separated from the strip.

The control of the position of each container before its entry into the severing station enables to correct any minor errors (also negligible) in the conformation of the container or of the strip as a whole. The correction, repeated for all the containers, prevents accumulation of these minor errors, which accumulation could lead also to significant and unacceptable errors in positioning the containers.

If the second sensors 11 have reported a faulty situation associated with one or more containers, or with a series of containers, the controller of the motor 9 is programmed to ensure that said containers pass rapidly, without stopping, through the severing station without therefore being subjected to the severing operation, so as to avoid operations that could be unnecessary because they are associated with containers that are destined to be rejected.

The controller can be programmed to cut the strip into portions comprising two or more containers, depending on requirements.

If the format of the containers is changed, so that the step of the containers is therefore changed, the control unit can be programmed to modify the angle of the step rotation of the dragging drum and to therefore modify the working cycle of the severing station so as to adapt it to the new advancing step of the containers.

Many different practical applicatory modifications of constructional details may be applied to the invention without thereby leaving the scope of the inventive idea that is claimed below.

1-12. canceled.

13. Device for transversally cutting into portions at least one continuous strip of containers, comprising:
a severing station arranged to receive the different containers of said strip in a preset severing position, one after another, intermittently;
a first motor device for actuating said severing station; a feeding line for indexing said strip of containers to said severing station with a controlled advancing step;
a second motor device for commanding the advancing of said strip towards said severing station.

14. Device according to claim 13, wherein said second motor device is distinct from said first motor device.

15. Device according to claim 13, wherein said second motor device is controlled by an electronic control unit.

16. Device according to claim 15, wherein said first motor device is also controlled by said electronic control unit.

17. Device according to claim 13, wherein said first motor device is controlled by an electronic control unit programmed to supply an alarm signal when at least one operating feature of said severing station is faulty, i.e. does not correspond to a preset proceeding.

18. Device according to claim 17, wherein said controlled operating feature is the stress-shift curve of at least one severing member.

19. Device according to claim 13, and further comprising at least one first sensor arranged upstream of said severing station to detect the position of each container of said strip in transit and to supply, for each container, a corresponding position signal; said second motor device being arranged to receive said position signal of the container and to therefore command said strip to advance, so as to correctly position said container in the preset severing position.

20. Device according to claim 13, and further comprising at least a second sensor arranged to detect a faulty situation of one or more containers arranged on said feed line upstream of said severing station, and to supply a relevant command signal, said second motor device being arranged to detect said command signal and to therefore command said strip to advance in such a way as to override the stationing at said severing station of the containers for which a faulty condition has been detected.

21. Device according to claim 13, wherein said second motor device comprises at least one brushless motor.

22. Device according to claim 13, wherein said first motor device comprises at least one brushless motor.

23. Device according to claim 13 wherein:
on said feed line is arranged a drum for dragging forward said strip, which can be rotated by command of said second motor device, with a rotation axis that is perpendicular to said advancing direction of said strip of containers, the drum being peripherally provided with seats to receive the containers, arranged in a circumference around said drum with a preset step corresponding to a step with which the containers are distributed on said strip;
said seats of the rotating drum are coupled with said containers of said strip to command said strip to advance towards said severing station;
said severing station comprises two cutting half-moulds that are opposed to said strip and are commanded to open and close by a known movement mechanism that is connected to an actuating shaft that receives movement from the first motor device.
